(19) United States
(12) Patent Application Publication
(10) Pub. No.: US 2025/0201144 A1
(43) Pub. Date: Jun. 19, 2025

(54) METHODS AND SYSTEMS OF AI-BASED AUTOMATED EDUCATIONAL CONTENT CREATION

(71) Applicants: DAN MCCANN, MILTON, GA (US); SCOTT DRAKE, ATLANTIC HEIGHTS, NJ (US); JIM MADDEN, GREENSBORO, GA (US)

(72) Inventors: DAN MCCANN, MILTON, GA (US); SCOTT DRAKE, ATLANTIC HEIGHTS, NJ (US); JIM MADDEN, GREENSBORO, GA (US)

(21) Appl. No.: 18/537,809

(22) Filed: Dec. 13, 2023

(51) Int. Cl. G09B 9/00; G06Q 50/20

(52) U.S. Cl. CPC G09B 9/00; G06Q 50/205

(57) ABSTRACT

A computerized method for automated educational simulation creation comprising: retrieving and ingesting a set of audio recordings and associated metadata; converting the audio recordings to a plurality of digital assets; discovering a trending issues based on a search of the metadata; identifying a set of key assets from the set of audio recordings and associated metadata; automatically creating a customized training simulation based on the set of key assets; and automatically publishing the customized training simulation by publishing and distributing customized training simulations to a plurality of agents

### CROSS-REFERENCE TO RELATED APPLICATIONS

### Background

### 1. Field

This application relates generally to artificial intelligence and a machine learning, and more particularly to a system, method and article of manufacture of AI-based automated educational content creation.

### 2. Related Art

Dedicating personnel to training and coaching contact center representatives is expensive, emotionally draining for training and hiring staff and seldom provides enough experience to make an agent ready for live contact with clients. There is a need for a digital solution to increase the efficiency and effectiveness of automated coaching/training at scale. This can lead to, inter alia, increased revenue per contact (e.g. call), better conversion rates, more sales per hour and improved CSAT scores. In this way, every agent can be trained to be both competent and confident to handle customer conversations in an automated and efficient manner.

### BRIEF SUMMARY OF THE INVENTION

In one aspect, a computerized method for creation of automated simulation flows comprising: ingesting an agent entity's media and instructional content; with an automated simulation creator: capture the agent entity's media and instructional content, converting any video content of the agent entity's media and instructional content into a plurality of screen views, and exporting the plurality of screen views to a creator's automatic speech recognition (ASR) tool; with a creator's ASR tool: convert any dual channel audio files of the agent entity's media and instructional content into a computer readable transcription; with a generative AI system: dynamically generate a library of educational exercises and simulations based on all the inputs of data of the agent entity's media and instructional content, and wherein the library of educational exercises and simulations comprises a robust set of tags that correlate to content, benchmark, QA, and performance metrics of the inputs of data of the agent entity's media and instructional content.

In another aspect, a computerized method for automated educational simulation creation comprising: retrieving and ingesting a set of audio recordings and associated metadata; converting the audio recordings to a plurality of digital assets; discovering a trending issues based on a search of the metadata; identifying a set of key assets from the set of audio recordings and associated metadata; automatically creating a customized training simulation based on the set of key assets; and automatically publishing the customized training simulation by publishing and distributing customized training simulations to a plurality of agents.

### BRIEF DESCRIPTION OF THE DRAWINGS

FIG. 1 illustrates an example process for AI-based automated educational content creation, according to some embodiments.

FIG. 2 illustrates an example process for creation of automated simulation flows, according to some embodiments.

FIG. 3 illustrates an example process for automated educational simulation creation, according to some embodiments.

FIG. 4 illustrates an example process for automated intelligent coaching, according to some embodiments.

FIG. 5 illustrates an example automated educational simulation creation system, according to some embodiments.

FIG. 6 depicts an exemplary computing system that can be configured to perform any one of the processes provided herein.

The Figures described above are a representative set and are not an exhaustive with respect to embodying the invention.

### DESCRIPTION

Disclosed are a system, method, and article of manufacture of AI-based automated educational content creation. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of flow charts for weight mapping and operations, example processes, hardware circuits etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Automatic speech recognition (ASR) can enable the recognition and translation of spoken language into text by computers. ASR can enable computer speech recognition, speech to text (STT), etc.

Chatbot is a software application that aims to mimic human conversation through text or voice interactions, typically online. A chatbots can be an AI systems capable of maintaining a conversation with a user in natural language and simulating the way a human would behave as a conversational partner. Such technologies often utilize aspects of deep learning and natural language processing.

Customer satisfaction (CSAT) is a marketing term that can be a measure of how services/client interactions provided by a company meet and/or surpass customer expectations. In some examples, CSAT can be defined as “the number of customers, or percentage of total customers, whose reported experience with a firm, its products, or its services (e.g. ratings) exceeds specified satisfaction goals.”

Experience API (xAPI) is an e-learning software specification that records and tracks various types of learning experiences for learning systems. Learning experiences are recorded in a Learning Record Store (LRS), which can exist within traditional learning management systems (LMSs). The integration can be through varies methods (API and services, xAPI, etc.).

Generative artificial intelligence (AI) systems/models can generate, inter alia: text, images, or other media in response to prompts. Generative AI models learn the patterns and structure of their input training data, and then generate new data that has similar characteristics.

Generative pre-trained transformers (GPT) are a type of LLM that can be utilized as a framework for generative artificial intelligence.

Large language model (LLM) is a computerized language model consisting of an artificial neural network with many parameters (e.g. tens of millions to billions), trained on large quantities of unlabeled text using self-supervised learning or semi-supervised learning. It is noted that other various NLP modeling techniques can be used besides LLM in some example embodiments.

Learning management system (LMS) is a software application for the administration, documentation, tracking, reporting, automation, and delivery of educational courses, training programs, materials or learning and development programs.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Natural language processing (NLP) is an interdisciplinary subfield of linguistics, computer science, and artificial intelligence concerned with the interactions between computers and human language, in particular how to program computers to process and analyze large amounts of natural language data.

Personally identifiable information (PII) can be any information related to an identifiable person.

### Example Architecture and Systems

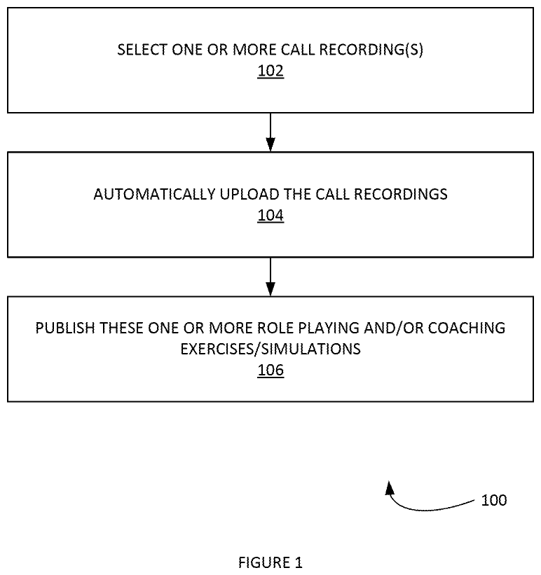

FIG. 1 illustrates an example process 100 for AI-based automated educational content creation, according to some embodiments. In step 102, process 100 can select one or more call recording(s). These can be automatically selected based on various criteria (e.g. relevancy to educational content to be created, quality/success of participant(s), internal scoring metrics, etc.). This can combine traditional plan, design, and capture steps into a single automated step.

In step 104, process 100 can automatically upload the call recordings (and/or other content/metadata) thereby skipping traditional storyboard and build steps. Process 100 can automatically generate one or more role playing and/or coaching exercises/simulations. In step 106, process 100 can publish these one or more role playing and/or coaching exercises/simulations.

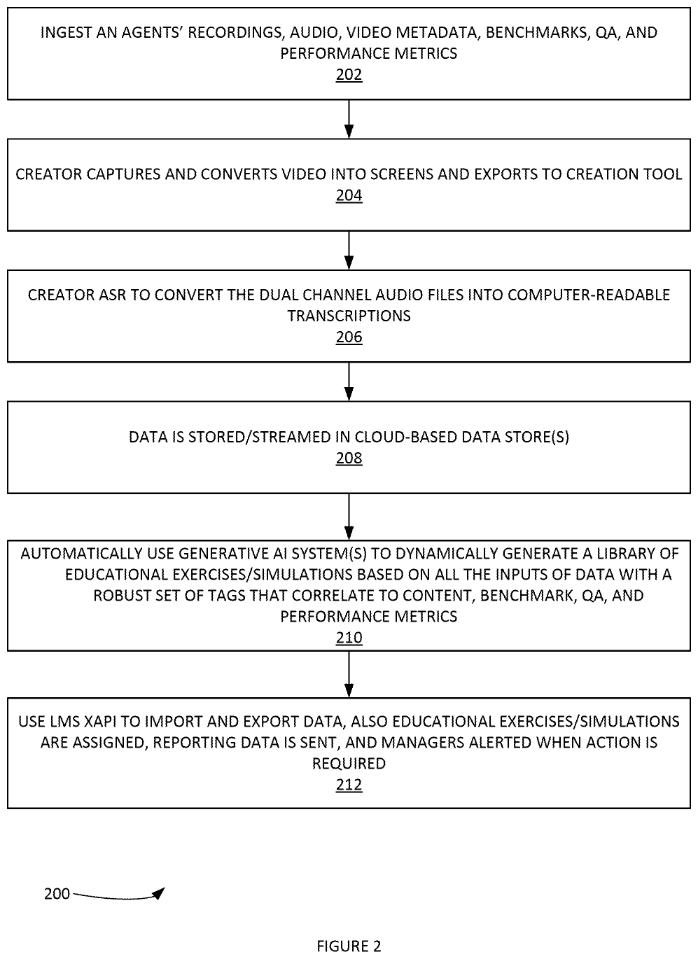

FIG. 2 illustrates an example process 200 for creation of automated simulation flows, according to some embodiments. Process 200 can ingest an agents' recordings, audio, video metadata, benchmarks, quality assurance (QA) metrics, performance metrics, etc. in step 202. Process 200 can enable the simulation creator to capture and/or convert video(s) into screen views and export to a creation tool in step 204.

Process 200 can enable the creator's ASR tool to convert the dual channel audio files into computer readable transcriptions in step 206. Data is stored/streamed in cloud-based data store(s) in step 208. Process 200 can automatically use generative AI system(s) to dynamically generate a library of educational exercises/simulations based on all the inputs of data with a robust set of tags that correlate to content, benchmark, QA, and performance metrics in step 210. Process 200 can use an LMS xAPI to import and export data, also educational exercises/simulations are assigned, reporting data is sent, and managers alerted when action is required in step 212.

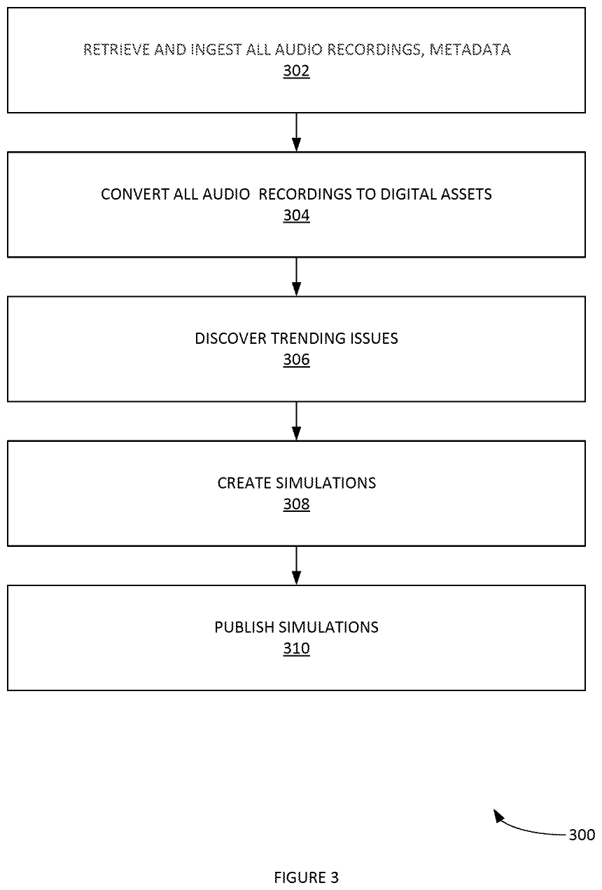

FIG. 3 illustrates an example process 300 for automated educational simulation creation, according to some embodiments. Process 300 can retrieve and ingest all audio recordings, metadata in step 302. Here process 300 can retrieve and ingest all audio recordings, metadata. Process 300 can convert audio recordings to digital assets in step 304. Process 300 can convert all audio recordings to digital assets (e.g. transcripts, metadata, redact PII, etc.).

Process 300 can discover trending issues in step 306. Process 300 can discover trending Issues. Process 300 can search all transcripts and clusters based on key metadata.

Process 300 can identify key assets (e.g. screenshots, scripts, etc.). Process 300 can create simulations in step 308. Process 300 can assemble key assets and build simulations. This is automated. Process 300 can also implement editor operations, scoring operations, test operations, etc.

Process 300 can publish simulations in step 310. Process 300 can publish and distribute customized training simulations to agents/trainees. Process 300 can also send scores and confirmation back to the customer's QA platform.

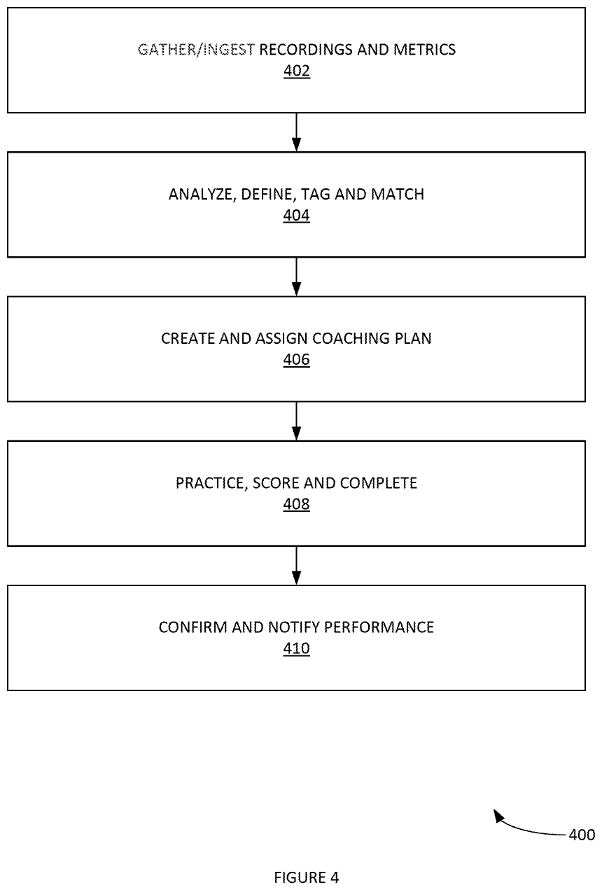

FIG. 4 illustrates an example process 400 for automated intelligent coaching, according to some embodiments. Process 400 can gather/ingest recordings and metrics in step 402. Process 400 can analyze, define, tag and match in step 404. Process 400 can create and assign coaching plans in step 406. Process 400 can practice, score and complete in step 408. Process 400 can confirm and notify performance in step 410.

Process 400 can gather and ingest agents' recordings, metadata, benchmarks, QA, and performance metrics. Process 400 can build out a simulation library with robust tagging to customize training and coaching plans for any agent. Process 400 can automate the coaching plan by assigning the appropriate simulations/modules to the agent based on proficiency needs and metrics. Process 400 can execute the coaching plan by running simulations and ensuring agents meet the metrics define in the coaching plan. Process 400 can confirm the coaching plan is completed and notify the benchmarking system with the individual agent's completion data and scores. Process 400 can integrate third-party APIs (e.g. Verint, Nice, Observe.ai, etc.) to ingest a feed of call recordings, metadata, and QA and performance metrics. Process 400 can use a generative AI to generate a set of tags for all simulations based on call recordings, metadata and metrics associated with QA and performance. Process 400 can build a tag-matching algorithm that matches QA and performance metrics to simulations tags from the simulation library. Process 400 can implement a coaching plan with the ability to define passing scores. Process 400 can integrate simulation output into QA and performance metric third-party APIs or use a method for scoring metrics. Process 400 can integrate scoring and complete data to third-party APIs. It is noted that agent/trainee inputs, scores and reviews can be maintained for later review by enterprise administrators/trainers. Agent/trainee inputs, scores and reviews can be used in ML methods to optimize later educational simulations.

### Example Systems

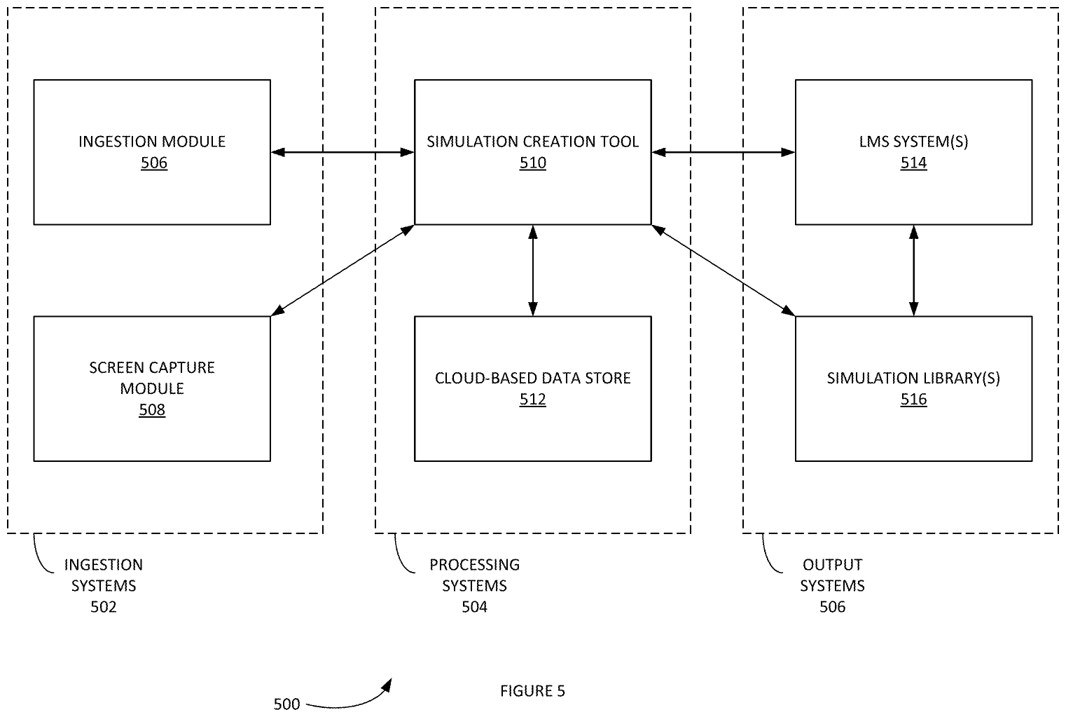

FIG. 5 illustrates an example automated educational simulation creation system 500, according to some embodiments. Automated educational simulation creation system 500 can be used to implement the various processes provided herein. More specifically, automated educational simulation creation system 500 implement processes 100-400 discussed supra. Automated educational simulation creation system 500 can be integrated with an enterprise's existing training/coach/education systems. automated educational simulation creation system 500 includes three subsystems. These include, inter alia: ingestion systems 502, processing systems 504, output system 506. Automated educational simulation creation system 500 can also include other systems not shown, such as, inter alia: email servers, text messaging servers, database management systems, natural language processing/natural language understanding systems, mathematical calculators, voice-to-text systems, optical character recognition systems system, AI/ML modeling systems, customer relationship management (CRM) systems, artificial intelligence chatbots (e.g. Generative Pre-trained Transformer (GPT) enabled chatbots that utilize of large language models (LLMs)), etc.

Ingestion systems 502 ingest data that can be used to generate educational simulations (e.g. coaching exercises/simulations as discussed supra). This can include audio, video, and metadata. Ingested data can be from third-party sources in some examples. For example, ingested data can be audio files of call-center calls. The calls can be selected for various training metrics (e.g. successful call, call with mistakes to be avoided, etc.). Ingested data can include screen shots of client interactions. Again, the screenshots can be obtained from third parties.

Ingestion module 506 ingests audio, video and/or metadata. Ingestion module 506 can include various functionalities for speech analytics and interaction analytics software, customer engagement management and/or business intelligence to implement the ingestion operations. It is noted that Ingestion module 506 is both ingestion module and output systems.

Screen capture module 508 can implement video capturing operations. Screen capture module 508 can convert the video captures into screenshots. Screen capture module 508 can be used for video capturing and the conversion of video files into screenshots. Screen capture module 508 can implement the creation and recording of video tutorials and presentations via screencast (e.g. a screen recording). Screen capture module 508 can use a variety of image capture methods, including, inter alia: full screen selection, specific region selection, menu selection, text recognition (e.g. OCR operations with Grab text) and panoramic selection. Alternatively, the Screen capture module 508 can record a video (e.g. from a specific region or full screen). The outputs of ingestion module 506 and screen capture module 508 are provided to simulation creation tool 510.

Processing systems 504 obtains the outputs of ingestion systems 502. Processing systems 504 include simulation creation tool 510, etc. Simulation creation tool 510 can analyze and process the output of ingestion system 502. Simulation creation tool 510 uses this output to create the educational simulations. The educational simulations can automatically create educational simulations that optimize the performance of trainees, employees, etc. The educational simulations can train and/or optimize the type of skills needed to perform a job and/or execute a client conversation, employee conversation, etc. These skills can include, inter alia: software navigation, specific interaction dialogues and actions, specific sales skills, employee interactions (e.g. as part of an equity training program), etc. The educational simulations can be a part of exercises that enable employees and professionals to practice and improve skill sets. The educational simulations can be included in employee workflows. AI/ML systems in the simulation creation tool 510 can monitor employee training sessions and/or job performance and feed them customized educational simulations within a workflow. ML methods (e.g. see infra) can be utilized to optimize the educational simulation content, customize the education simulation content, as well as the placement/time of educational simulations themselves within a workflow. The educational simulations can be coaching exercises for sales, service and support roles. Simulation creation tool 510 can create realistic simulations that reflect real-world sales, service and support role activities. These educational simulations can sent to output systems 506 and/or stored in cloud-based data stores 512.

In other example embodiments, simulation creation tool 510 can automatically create realistic simulations for other professional and educational activities such as legal activities, public speaking, medical professional interactions, etc. These can be created from ingested data from the various fields (e.g. videos and audio recordings of professional and educational activities such as legal activities, public speaking, medical professional interactions, etc.).

Output systems 506 can include various LMS systems 514. LMS systems 514 can include cloud-based people development software provider and learning systems. LMS systems 514 can include course management systems. The educational simulation output can include a combination of ASR transcriptions for both an agent/trainee and a coach (e.g. can be an AI coach, human coach, or a combination thereof) with the screenshots of a draft simulation (e.g. with a script and interactive screen flows, etc.). These can be provided via simulation library(s) 516.

For example, simulation creation tool 510 can perform ASR on this output to convert the dual channel audio files into transcriptions. Simulation creation tool 510 uses the transcriptions to generate the educational simulations and screenshots. Simulation creation tool 510 can leverage generative AI models (e.g. ChatGPT®, Bing Chat®, BARD®, etc.) and AI chatbot(s) systems to improve simulations. Additionally, various ML optimization algorithms can be used to further train and improve simulation performance (e.g. see infra).

The creation of an educational simulation can be based on a request from a training team or other administrator. For example, a call center training coach can request the creation of various educational simulations with specific parameters to obtain certain goals in the training process. In another example, an AI coach can monitor call center employees during calls and automatically assess performance. The AI coach can the automatically request the generation of education simulation that are tailored to each trainees/employees weaknesses.

### Additional Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (for example in cross-validation), the test dataset is also called a holdout dataset.

### Additional Example Computing Systems

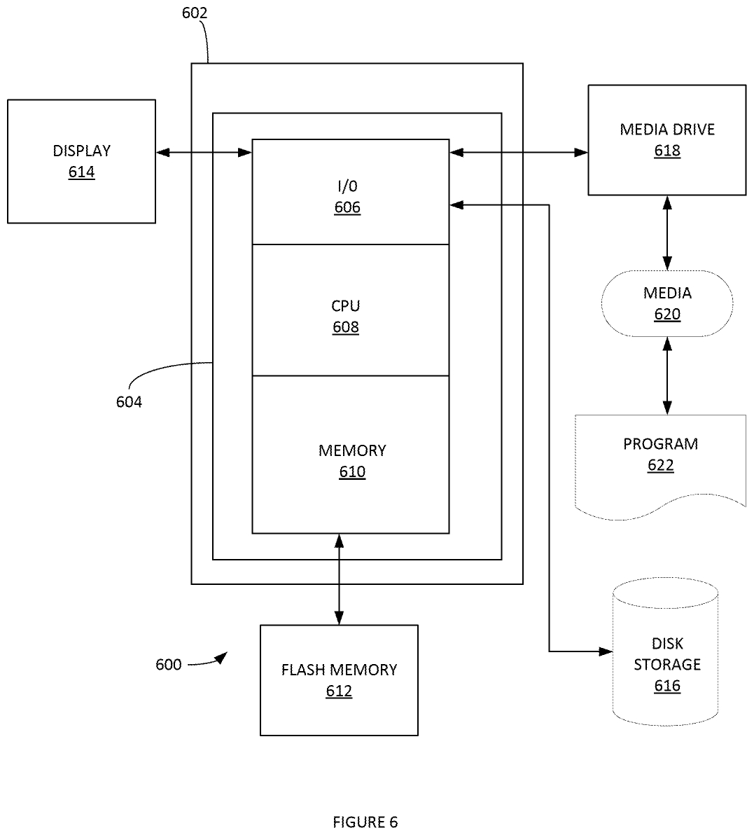

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

It is noted that call recording software providers for access to call recording content. CCaaS system providers can, for access to call recording content, perform software system screen capture when available, some QA scores when available, as well as delivery into agent desktop. A WFX system provides for access to call recording, software system screen capture when available, QA software system screen capture when available, some QA scores when available, as well as delivery and scheduling into agent desktop for access during non-occupancy or idle times. QA system providers can provide for access to call recordings when available, QA scores when available, as well as delivery and scheduling into agent desktop for access during non-occupancy or idle times.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transistor form of machine-readable medium.

What is claimed as new and desired to be protected by Letters Patent of the United States is:

1. A computerized method for creation of automated simulation flows comprising:
ingesting an agent entity's media and instructional content;
with an automated simulation creator:
capture the agent entity's media and instructional content,
converting any video content of the agent entity's media and instructional content into a plurality of screen views, and
exporting the plurality of screen views to a creator's automatic speech recognition (ASR) tool;
with a creator's ASR tool:
convert any dual channel audio files of the agent entity's media and instructional content into a computer readable transcription;
with a generative AI system:
dynamically generate a library of educational exercises and simulations based on all the inputs of data of the agent entity's media and instructional content, and
wherein the library of educational exercises and simulations comprises a robust set of tags that correlate to content, benchmark, QA, and performance metrics of the inputs of data of the agent entity's media and instructional content.

2. The computerized method of claim 1 further comprising:
using a learning management system (LMS) Experience API (xAPI) to import and export data.

3. The computerized method of claim 2 further comprising:
assigning a plurality of educational exercises and simulations of the library of educational exercises and simulations.

4. The computerized method of claim 3 further comprising:
detecting that an action is required on the part of an agent trainee.

5. The computerized method of claim 4 further comprising:
automatically alerting a manages alerted when it is detected that an action is required.

6. The computerized method of claim 1, wherein the agent entity's media and instructional content comprises at least one of an agent entity's recordings, an agent entity's audio, an agent entity's video metadata, an agent entity's benchmark, an agent entity's quality assurance (QA) metrics, or an agent entity's performance metric.

7. A computerized method for automated educational simulation creation comprising:
retrieving and ingesting a set of audio recordings and associated metadata;
converting the audio recordings to a plurality of digital assets;
discovering a trending issues based on a search of the metadata;
identifying a set of key assets from the set of audio recordings and associated metadata;
automatically creating a customized training simulation based on the set of key assets; and
automatically publishing the customized training simulation by publishing and distributing customized training simulations to a plurality of agents.

8. The computerized method of claim 7, wherein the digital assets comprise a transcript, the associated metadata, and a redacted personal data (PII).

9. The computerized method of claim 8, wherein the digital assets comprise a set of screenshots and a set of transcripts derived from the set of audio recordings and associated metadata.

10. The computerized method of claim 9, wherein the step of discovering a trending issues is based on searching a set of transcripts of the audio recordings.

11. The computerized method of claim 10, wherein the training simulations are created using one or more editor operations, one or more scoring operations, and one or more test operations.

12. The computerized method of claim 11, wherein the set of audio recordings and associated metadata comprises a feed of agent call recordings, metadata of agent call recordings, and quality assurance (QA) and performance metrics of agent call recordings.

13. The computerized method of claim 12 further comprising:
using a third-party application programming interface (API) to ingest a feed of call recordings, metadata, and QA and performance metrics.

14. The computerized method of claim 13 further comprising:
sending the agent scores and confirmations to a customer's Quality Assurance (QA) platform.

15. The computerized method of claim 14 further comprising:
using a generative AI system to generate a set of tags for the simulation based on the feed of call recordings, metadata, and QA and performance metrics.

16. The computerized method of claim 15 further comprising:
implementing a coaching plan for each agent, wherein the coaching plan defines a passing score for the agent using the simulation.

17. The computerized method of claim 16, wherein the agent inputs, scores and reviews maintained for review by an enterprise trainers.

18. The computerized method of claim 17, wherein the agent inputs, scores and reviews maintained for training and verification operations by a Machine Learning system to optimize later training simulations.
